(19) United States
(12) Patent Application Publication
(10) Pub. No.: US 2008/0288892 A1
(43) Pub. Date: Nov. 20, 2008

(54) SYSTEM AND METHOD OF PRESENTING TELEPHONE FUNCTIONS AS INTERACTIVE ELEMENTS ON AN ELECTRONIC DEVICE

(75) Inventor: Alison Mettler, Arroyo Grande, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/027,264

(22) Filed: Feb. 6, 2008

Related U.S. Application Data
(60) Provisional application No. 60/888,542, filed on Feb. 6, 2007.

(51) Int. Cl. G06F 3/048

(52) U.S. Cl. 715/840

(57) ABSTRACT

A system, method, and user interface of presenting telephone functions as interactive elements on an electronic device with telephone capabilities such as a mobile device is disclosed. The system and method provides a user with a mechanism for focusing on a call, where the call is selected by user activation from one or more calls occurring on the mobile device. The system and method displays contextual buttons related to the call to the user, where the contextual buttons are configured for operating on the call.

### PRIORITY CLAIM

This application claims the benefit under 35 U.S.C. § 119(e) of U.S. Provisional Patent Application No. 60/888,542 filed on Feb. 6, 2007, entitled “Method of Presenting Telephone Functions as Interactive Elements on a Mobile Device,” which is herein incorporated by reference.

### FIELD OF THE INVENTION

The present invention generally relates to a system and method for managing calls and connected parties on a electronic device with telephone capabilities, and more particularly, to a system and method for presenting telephone functions as interactive elements on a display screen of electronic systems and devices with telephone capabilities such as mobile phones and personal digital assistants.

### BACKGROUND OF THE INVENTION

Existing electronic systems and devices (hereinafter referred to collectively as electronic devices) having processing capability, such as mobile devices (e.g., cell phones, personal digital assistants) and information appliances, typically have a myriad of ways in which a user can interact with the electronic device. Although electronic devices and systems with telephone capabilities such as mobile devices or mobile handsets offer increasing ability today for users to participate in multiple simultaneous phone calls including multi-party conference calls, these devices do not provide a user with a way to easily manage calls and connected parties.

In order for a user to be able to effectively use the mobile device for such purposes, the user of a mobile device that supports these features must be able to interact with those calls as a whole (i.e. to end the entire conference call) or to interact with only a particular conference call participant (i.e. in order to end the call with that participant only). The mobile devices that support these features do not provide a context in which to perform actions. For example, one drawback is that there is no mechanism to end a call simply by using the on-hook button. Another drawback is that there is no mechanism that allows the user to easily move focus between calls and keep track of which calls and call participants.

Because display screen sizes particularly on mobile devices are small and offer restricted space, a full set of command buttons for each call cannot be provided especially when there are multiple calls in operation. Moreover, because a user may have conference calls with multiple participants, it is not sufficient to merely provide interactive elements to control operations of the calls, but also interactive elements that allow a user to control operations in relation to each participant in the conference call. However, presenting too many similar types of interactive elements allowing would be extremely confusing for the user.

Accordingly, there exists a continuing need for improved user interface techniques that allow a user of an electronic device with telephone capabilities such as a mobile device to efficiently and easily interact with multiple phone calls and call participants. These and other advantages may be provided by various embodiments of the present invention.

### SUMMARY OF THE INVENTION

The present invention discloses a system, method, and user interface for presenting improved telephone functions as interactive elements on a electronic device such as a mobile device. In accordance with an exemplary embodiment, the interactive elements are provided on a display screen and allow a user to control operations of the calls as well as operations relating to each participant in a call.

In accordance with one aspect of the present invention, the system and method permits the user to focus on a call, where the call is selected by user activation from one or more calls occurring on the mobile device.

In accordance with another aspect of the present invention, the system and user interface of the present invention display contextual buttons relating to the calls, where the contextual buttons are configured for operating on the calls.

Additional features and advantages of the invention will be set forth in the description which follows, and in part will be obvious from the description, or may be learned by practice of the invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an exemplary electronic device such as a mobile device for utilizing the present invention;

FIG. 2 is a representation of an exemplary embodiment of the interactive elements in accordance with the present invention;

FIG. 3 is a representation of the interactive elements of the present invention; and

FIG. 4 is representation of the interactive elements of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

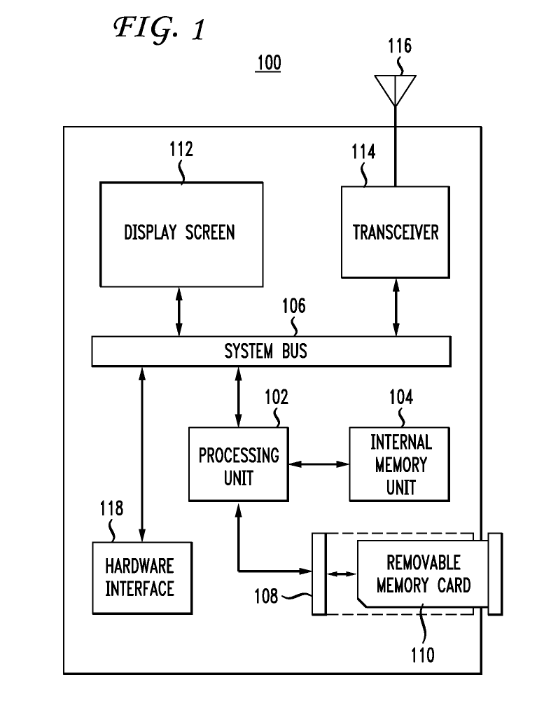

FIG. 1 shows elements of an exemplary mobile device 100 embodied in accordance herewith for executing methods of the present invention and may comprise a portable computer, a personal digital assistant (PDA), and enhanced cell phone, or any other computer system having a relatively small display screen, and preferably having wireless communication capability. The mobile device includes a processing unit, 102, adapted to run an operating system platform and application programs. The processing unit 102 is also adapted to control other complements of the mobile device as explained herein. An internal memory unit, 104, may comprise a read-only memory (ROM) to store critical files and a random access memory (RAM) to store other files as needed. The mobile device of FIG. 1 may also include the removable memory card interface 108 as to accommodate the memory card 110.

A display screen 112 is coupled to the processing unit 102 through a bus 106 and thereby receives input from the processing unit 102 that provides displays on the screen 112. The system of FIG. 1 also includes a transceiver unit 114, coupled to an antenna 116 and to the processing unit 102. The transceiver 114 provides for transmission and reception of wireless signals over a designated range of frequencies, allowing the mobile device connections external devices and networks, such as a wireless telephone network or the internet. Data received from external sources via the transceiver 114, such as media content obtained from an online depot may be delivered via the bus 106 to the processing unit 102 and thereafter stored in available memory. As depicted in FIG. 1, a hardware interface 118 is coupled to a keypad or switches on the body of the mobile device.

Because of the limited size of the display screen 112, it is not possible to show a full set of visible command buttons in each graphical representation of a call because there can be more than one call in operation at a time. Because calls can be not just a call between two participants, but a conference call with multiple participants, it is not enough to merely represent and provide operations for the call in operation. A user should be able to perform actions on representations of each individual conference call participant. Moreover, buttons and actions must be closely associated with the objects on which they act. Presenting multiple sets of similar buttons can be confusing to users.

Therefore, a list-like method of presenting, navigating to, and selecting calls is a more ideal use of the limited screen real estate on a mobile device. The list-like method displays information about the call or caller and also allows for the user to “enter” a call and select its participants individually, in order to perform actions on individual conference call participants.

In addition, this method reduces buttons on the screen to the minimum amount that are necessary to operate a call. Further, the buttons can be contextual to the selected item.

In accordance with one embodiment of the present system, two calls can be received at any one time. Calls are presented as a list, which a user can easily navigate. Callers within a conference call are treated the same way, by being arranged in a list that can be easily navigated by a user.

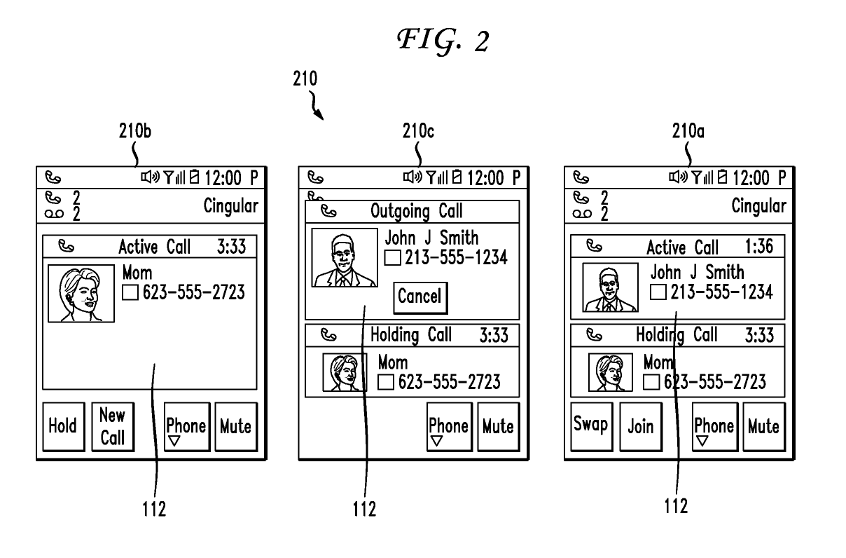

FIG. 2 illustrates generally by reference numeral 210 three diagram representations illustrating the user interface system and method of an exemplary embodiment of the present invention. The diagram representation to the right indicated by 210a shows a front face of an exemplary mobile device with a display screen 112. A single call is illustrated as the point of focus on the display screen 112 by default. The diagram representation to the left indicated by 210b illustrates a display of contextual buttons, which are configured to operate on the single call that is the point of focus of the exemplary mobile device.

Referring now to the center diagram indicated by 210c, the current call that is shown “on hold” while another call is being placed by the mobile device. The outgoing call that is being placed is therefore shown as the one that is the point of focus. The buttons that appeared at bottom-left that were indicated before are no longer displayed because those operations cannot be performed on the outgoing call as it has not yet been connected.

The diagram to the right indicated by 210a that is illustrated shows an exemplary situation where two calls are received, and one call is “on hold” while the other call is active. The active call is illustrated as the point of focus so the buttons at bottom-left pertain to the call that is active.

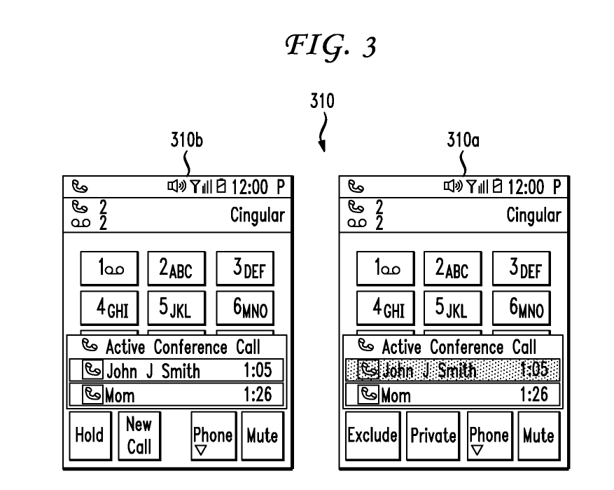

Referring now to FIG. 3, indicated generally by 310, there is shown an exemplary embodiment whereby two calls are coupled into a conference call, which is active and illustrated as the point of focus by default. The buttons that appear at the bottom-left pertain to the active conference call because it is the one which is the point of focus and is shown as highlighted.

The diagram to the right indicated at 310a illustrates an exemplary situation of selecting a single participant from the conference call. The buttons that appear at the bottom-left of the display screen 112 pertain to the participant since the participant is selected. The conference call has a secondary point of focus.

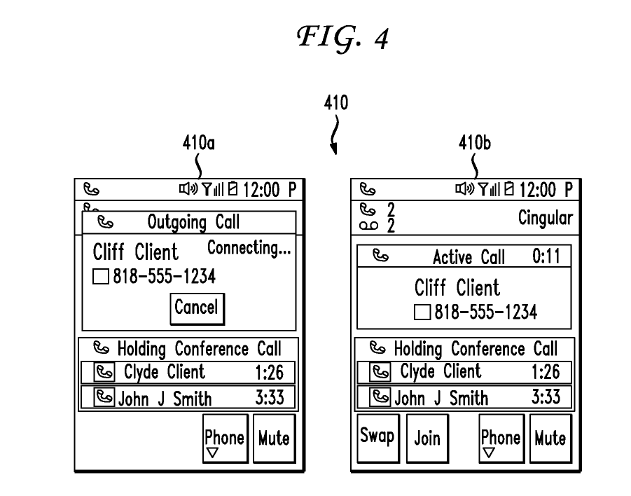

Referring now to FIG. 4, indicated generally by reference numeral 410, the diagram to the left indicated by 410a illustrates an example where an outgoing call is placed and is the point of focus and therefore highlighted. The conference call is illustrated as being “on hold.” The buttons that appear at the bottom-left are no longer on display because those operations cannot be performed on the outgoing call because it has not yet been connected.

The diagram to the right, indicated generally by reference numeral 410b illustrates an example of a single call being active and being the point of focus. The buttons that appear at the lower-left pertain to the call that is the point of focus. The conference call is “on hold” and is illustrated as not being the point of focus.

It will be understood that the contextual telephone interface of the invention can be employed for any application that requires display and management of multiple connections or parties to whom a user is connected. For example, group chats and shared editing environments where the editor is announced to other participating editors, or other shared or collaborative environment where there is a hierarchy of selection and an interest in identifying participants are environments where the contextual interface is applicable.

It is to be understood that the foregoing illustrative embodiments have been provided merely for the purpose of explanation and are in no way to be construed as limiting of the invention. Moreover, the words used here are words of description and illustration, rather than words of limitation. In addition, the advantages and objectives described here may not be realized by each and every embodiment practicing the present invention. Further, although the invention has been described in this application with reference to particular structure, materials and/or embodiments, the invention is not intended to be limited to the particulars disclosed here. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of presenting telephone functions as interactive elements on an electronic device with telephonic capability, said method comprising the steps of:
providing an indication of focus on a particular call, said particular call selected by user activation from one or more calls occurring on the electronic device; and
displaying contextual buttons related to the particular call that is the point of focus, the contextual buttons configured for executing a plurality of instructions on the particular call in focus.

2. A method according to claim 1, wherein the contextual buttons are graphical representations or icons on the display screen.

3. A system of presenting telephone functions as interactive elements on an electronic device with telephonic capability, the system comprising:
a processor for providing an indication of focus on a particular call, the particular call selected by user activation from one or more calls occurring on the electronic device; and
a display of contextual buttons related to the particular call that is the point of focus, the contextual buttons configured for executing a plurality of instructions on the particular call in focus.

4. A system according to claim 3, wherein the contextual buttons are graphical representations or icons on the display screen.
